(19) United States
(12) Patent Application Publication
(10) Pub. No.: US 2015/0099048 A1
(43) Pub. Date: Apr. 9, 2015

(54) METHODS FOR PRODUCING MAPLE SAP WATER

(71) Applicant: PURELY MAPLE, LLC, Lewes, DE (US)

(72) Inventors: Chaim TOLWIN, Sundown, NY (US); Shlomo Aryeh TOLWIN, Southfield, MI (US)

(21) Appl. No.: 14/506,410

(22) Filed: Oct. 3, 2014

Related U.S. Application Data
(60) Provisional application No. 61/886,262, filed on Oct. 3, 2013.

(51) Int. Cl. A23L 2/385; A23L 2/42; A23L 1/09

(52) U.S. Cl. CPC A23L 2/385; A23L 1/09; A23L 2/42; A23V 2002/00
USPC 426/490; 426/524; 426/506

(57) ABSTRACT

A method for producing a beverage product from maple sap. The sugar content of the maple sap is modified to a predetermined level and the resulting beverage is subjected to high pressure in order to sanitize the beverage without fouling the taste. Frozen storage techniques are applied in order to allow the beverage to be sold year-round.

### CROSS-REFERENCE TO RELATED APPLICATIONS

This application claims benefit of U.S. Provisional Patent Application No. 61/886,262, entitled “METHODS FOR PRODUCING MAPLE SAP WATER,” filed on Oct. 3, 2013, which is hereby incorporated by reference herein in its entirety.

### FIELD OF THE DISCLOSURE

In some embodiments, the present disclosure relates generally to an apparatus, system, and method for beverage production. For example, in one implementation, a system facilitates filtration and refinement of maple sap into a beverage which is subsequently packaged and sold to consumers.

### BACKGROUND OF THE DISCLOSURE

The xylem sap of certain trees, particularly species of maple, includes significant sugar content during a particular part of the year. The sap is typically extracted from trees during the appropriate season and then filtered and refined to form maple syrup. Because the maple sap itself is only roughly between 1% and 2.5% sugar, evaporation, reverse osmosis, and other mechanisms are typically used to extract the water and create the syrup, which is approximately 66% sugar.

A variety of “natural” or “raw” whole beverages have been successfully marketed in recent years, and there is an established need for drinks that are produced directly from natural sources without mixing or including artificial ingredients. Such beverages are prized for having a certain signature taste, and preserving the taste is an important part of the manufacturing and packaging process for these beverages.

In order to meet consumer protection standards, beverages must undergo treatment to be substantially free of contamination. One treatment process common for mass production is ultra-high temperature (“UHT”) treatment in which liquids are subjected to high temperatures, often in excess of the product's boiling point, for short periods of time. However, UHT treatment can significantly alter the chemical properties of a beverage and therefore significantly modify the taste.

A method is therefore needed that allows natural maple beverage to be sold year-round without fouling the taste.

### SUMMARY

The present disclosure describes illustrative, non-limiting embodiments of systems, apparatuses, and methods that can be used to facilitate the production of maple sap water as a beverage. In one implementation, maple sap is extracted and, rather than being subjected to a maximal reverse osmosis process followed by evaporation in order to produce syrup, it undergoes a limited and controlled reverse osmosis process followed by sanitation and packaging. In another implementation, a reverse osmosis process results in a dehydrated maple product that is frozen for storage, then later thawed and rehydrated to produce a maple beverage at the desired concentration. Storage, packaging, and sanitation methods are selected to keep the maple products below a predetermined temperature at all times, such as below 100° C., so as not to foul the taste.

The result of this procedure is a natural beverage with the taste and sweetness of maple sugar, and containing only the ingredients provided by the maple tree itself. The beverage meets consumer protection standards for sanitation and can be sold year-round while having the same taste as it did fresh from the maple tree.

A process for making maple sap water may include the steps of: testing maple sap to determine that the maple sap has a first sugar content, applying a controlled reverse osmosis process to the maple sap in order to produce maple sap water having a sugar content that is within predetermined desired sugar level range, and testing the resulting maple sap water after applying the controlled reverse osmosis to determine that the maple sap water has a second sugar content that is higher than the first sugar content and within the desired sugar level range. The process may further include applying sanitation and packaging procedures to the maple sap water suitable for distribution as a beverage.

### BRIEF DESCRIPTION OF THE DRAWINGS

The included flowcharts illustrate the steps of a maple sap water refinement and packaging process in accordance with embodiments of the present invention.

FIG. 1 is a flowchart describing steps of a process for producing a maple water beverage product according to embodiments of the present invention.

FIG. 2 is a flowchart describing steps of a process for producing a maple water beverage product according to embodiments of the present invention.

FIG. 3 is a flowchart describing steps of a process for producing a maple water beverage product according to embodiments of the present invention.

### DESCRIPTION OF THE DISCLOSURE

These exemplary processes represent non-limiting embodiments and may be varied from what is described herein using the knowledge of one skilled in the art.

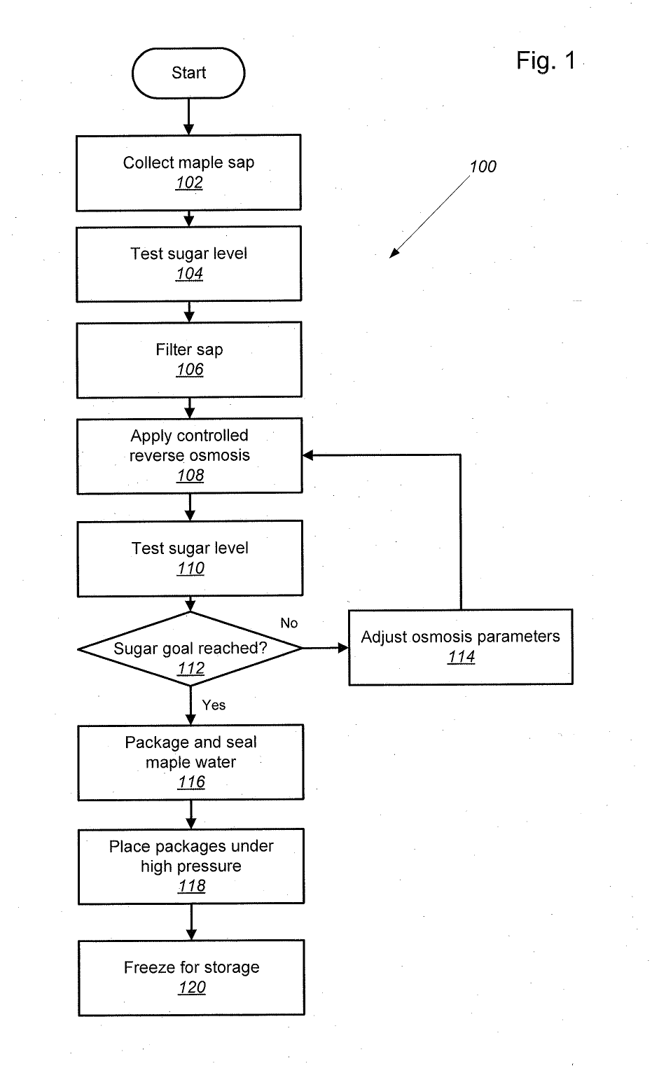

FIG. 1 illustrates a process 100 for manufacturing and packaging a maple sap water beverage using reverse osmosis and high pressure pasteurization.

Maple sap is collected (102). The sap is typically collected directly from trees and deposited in a sugar house for immediate processing. Alternatively, the sap could be transported from its collection site to another location for processing. Sap is typically collected from sugar maple or black maple trees in a northern climate, where the trees store starch during the winter and convert it to xylem sap in the spring.

In some implementations, the maple sap is collected into storage tanks which may hold multiple thousands of gallons. Active transport such as pumping may be used to draw the sap out of the storage tanks for further processing. Some components of sap collection and transport may be gravity-fed.

One of ordinary skill in the art will recognize various methods in the collection, transportation, and aggregation of sap, any of which can be used to acquire the sap necessary for the processing steps described herein.

The sugar level is tested (104). Prior to processing the sap, tests may be performed to verify that the sap meets certain expectations. For example, the sugar level of the sap may be measured. In some implementations, the sugar level of the sap may be measured by testing the viscosity of the sap, such as with a hydrometer.

The initial sugar level of the sap will depend on a number of conditions, such as the species and heritage of the particular trees being collected, the climate, the particular weather conditions of the season, and even the daily temperature and humidity. Freshly collected sap may be expected to be in the range of 1%-2.5% sugar, although unprocessed sap of higher and lower sugar concentrations are known in the art based on environmental conditions, the time of the season, and the particulars of the maple trees from which the sap is collected.

In some implementations, certain steps, such as the testing of the sugar level of the sap, may not be performed every time that the sap is processed. The sugar level may be tested periodically to confirm the sugar content of the collected sap; alternatively, the sugar level may only be tested when initially calibrating the reverse osmosis device and when making any further adjustments to the process.

In some implementations, the sap may be run through one or more filtration devices as part of processing (106). Sap filtration may occur before or after the sap is subjected to reverse osmosis, or both. The sap may be run through filtration designed to remove unwanted particles larger than the suspended sugars and nutrients, and may further include mechanisms to precipitate out, chemically attract, or otherwise eliminate unwanted substances from the sap.

In some implementations, the reverse osmosis machine may also include pre-filtration functionality. For example, the Springtech Elite reverse osmosis device mentioned below has a series of 200 micron pre-filters.

The maple sap product is subjected to a controlled reverse osmosis process (108). Because the sugar particles in sap are larger than water molecules, the concentration of sugar in the product can be raised by running the sap through a machine where it passes over a set of membranes under pressure. The membranes are of a size to be at least partially permeable to water but generally impermeable to the other, larger particles in the sap, so that water is removed from the sap while leaving the sugar and nutrients intact.

Reverse osmosis is sometimes used in the creation of maple syrup to supplement evaporation processes. Typically when creating syrup, the reverse osmosis device is configured to remove as much of the water as the reverse osmosis process is capable of removing; these machines can sometimes generate a product of 8% sugar level or higher. The sugar level of the product does not need to be precisely calibrated because the product then goes through further evaporation.

In contrast, in the exemplary process described herein for creating maple sap water, a controlled reverse osmosis process is used and the resulting sugar level is closely controlled. This is because, in some implementations, the reverse osmosis process is the last step that substantively changes the concentration of the mixture, so whatever sugar level results from the process may be the approximate sugar level of the maple sap water as packaged and sold. Because the sugar content of the resulting product is managed to a particular predetermined level, this controlled reverse osmosis process is distinct from the maximal reverse osmosis sometimes used in conjunction with evaporation for the production of maple syrup.

In some implementations, the controlled reverse osmosis process is performed by a reverse osmosis device with flow features that are adjustable so that the device can perform the osmosis to the desired sugar level. For example, the Springtech Elite line of reverse osmosis devices includes a concentrate flow regulating valve and a concentrate pressure regulating valve. By modifying the concentrate flow and pressure, the amount of osmosis that occurs over the reverse membranes in the device may be adjusted, which in turn adjusts the sugar level of the resulting product.

Following the reverse osmosis process, the sugar level may be tested again to verify that it falls within the desired range (110). This may be done as above by testing the viscosity of the resulting process with a hydrometer or other device. In some implementations, the flow characteristics of the concentrate and permeate components may be measured by the reverse osmosis device and used to determine the sugar level without the use of a separate measurement device.

In some implementations, the desired sugar level may vary depending on further steps in the process, such as the nature of the sanitation and packaging process used on the maple sap water. In some implementations, the desired sugar level may be between about 2.5% and 5%. While this sugar level is higher than that expected by natural sap processes alone, it is significantly lower than the usual product of unrestrained reverse osmosis used as part of the maple syrup creation process.

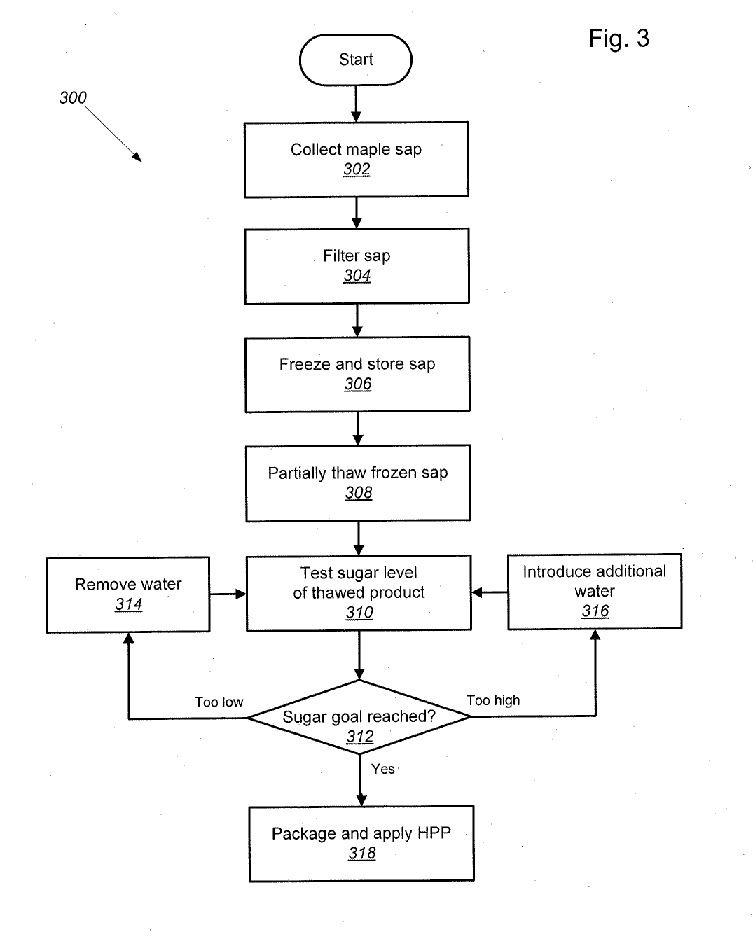

In some implementations, if the maple sap water is processed and packaged using a heatless high pressure pasteurization process (as further described below and shown in FIG. 3), then the desired sugar level may be between about 3% and 3.3%.

The sugar level may be compared against a goal level (112), and if the goal level is not yet reached, the device responsible for reverse osmosis may be adjusted so as to meet the goal level (114). As described above, the reverse osmosis process may be adjustable, such as by using a reverse osmosis device that allows for fine adjustment of the flow parameters. If the sugar level is ever tested and fails to fall within the desired range, then adjustments may be made to the reverse osmosis process until the product emerging from the process matches the acceptable sugar level value range. In some implementations, this may involve the continuous processing of new product under modified flow parameters rather than re-processing product that has already been processed.

In some implementations, the sugar level testing and reverse osmosis adjustment may represent steps performed at start-up that are repeated only infrequently once process is producing maple sap water at the desired sugar level. Depending on the sensitivity of the equipment and variation in sugar level, one of ordinary skill may recognize that daily or weekly tests may be sufficient to maintain the process within the expected sugar level range. In some implementations, the system may include continuous monitoring (such as monitoring of the flow characteristics of the concentrate and permeate by the reverse osmosis device) which may act as a first-level alert if the process deviates significantly from expectations.

The maple sap water may be sterilized by subjecting the maple sap water to high pressure without the use of heat, a process known as “high pressure processing” or “HPP”. Typically this process will involve first packaging and sealing the beverage (116), and then subjecting the beverage containers to high centrifugation in order to sanitize the beverage (118).

HPP is advantageous over other methods of sanitary treatment because it does not subject the product to high temperature, and therefore more accurately preserves the original flavor of the beverage than other treatment techniques. However, the shelf life of maple sap water submitted to HPP is only about four to twelve weeks when stored as a refrigerated liquid, as compared to a year or more for other sanitation techniques. Because maple sap is harvested at a particular time of year, a shelf life measured in weeks would not allow maple sap water to be sold year-round.

Therefore, in some implementations, some of the produced maple sap water beverage may be frozen for storage (120). The frozen maple sap water may be sold frozen or may be later thawed and sold. Unlike refrigerated storage, maple sap water subjected to HPP and then frozen has a shelf life of up to a year. Thus, by storing some of the beverage as frozen, maple sap water with the original, fresh, unfouled taste can be sold year-round.

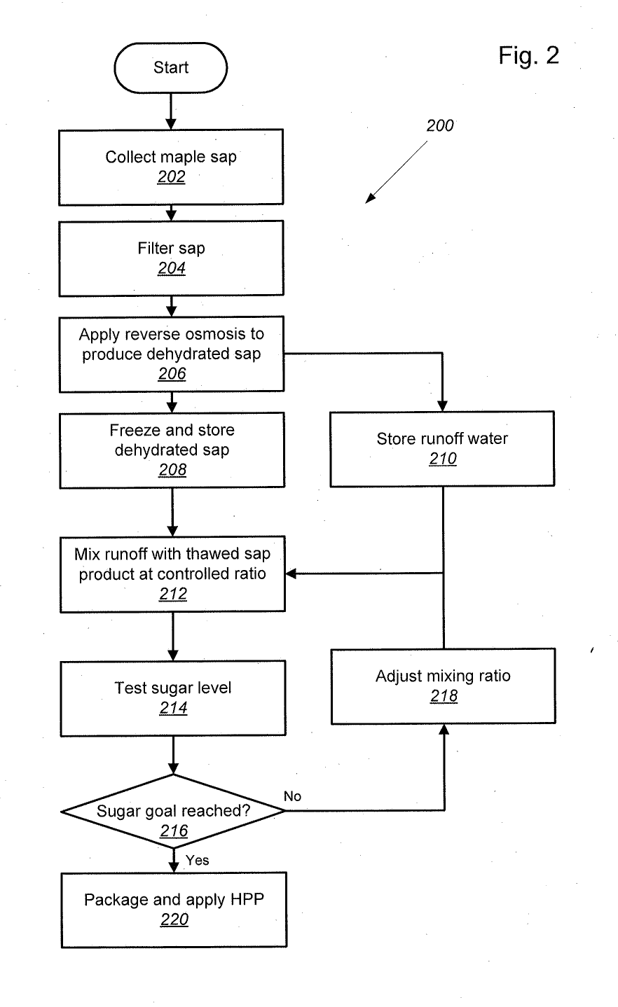

Another exemplary method 200 of freezing and storing maple sap water is illustrated as FIG. 2. It will be recognized that this process represents one exemplary method of storing maple sap water for later sale, and that variations will be recognized by one of ordinary skill in the art.

The maple sap may be collected and filtered as described above (that is, steps 202 and 204 may be similar to steps 102 and 104 as described above). However, unlike the reverse osmosis processes described above, in some implementations of this method 200, the maple sap may be subjected to additional reverse osmosis in order to remove additional runoff water from the maple sap, thus providing a product that is dehydrated compared to a maple sap water beverage product (206). The resulting maple sap product may have a higher sugar content than the maple sap water product described above.

The dehydrated maple sap product may then be stored frozen (208), while the runoff may be separately stored at higher temperatures (210). In some implementations, the runoff may be 75% or more of the total volume of the maple sap water, and may be safely stored at refrigerated or room temperature at a cost that is greatly reduced relative to the cost of frozen storage.

Later, the sap product may be thawed and the runoff water re-mixed in order to form a maple sap water beverage (212). The mix ratio may be selected to produce maple sap water with a sugar level selected as described above, by testing the resulting sugar level (214) and, if necessary 216), adjusting the mixing ratio as necessary to achieve the desired sugar level (218).

Once maple sap water of the appropriate sugar level is produced by re-mixing the frozen and thawed maple sap product with the stored runoff water, the product may be packaged and sanitized (220). By using a sanitation method that does not significantly heat the product, such as HPP, the product's flavor is preserved as the temperature never exceeds a particular value—all of the steps of the manufacturing, storage, retrieval, packaging, and sanitation process stay below any temperature at which the taste is significantly changed.

Not all implementations include each of the above steps. For example, in some implementations, water other than runoff water may be mixed with the dehydrated product in order to rehydrate it. Furthermore, where the runoff is used, some implementations may not include coordinating to match runoff water with the sap from which it came. The maple water runoff may therefore be supplied to rehydrate different thawed maple sap than the sap from which the runoff was originally drawn.

FIG. 3 illustrates another method 300 for producing a maple sap water beverage of predetermined sweetness by means of freeze distillation. In this implementation, maple sap is collected (302) and filtered (304) as described above.

The maple sap is then frozen and stored (306). In some implementations, the storage may be relatively brief and may coincide with transport. As described above with respect to freezing, the frozen maple sap may be kept under conditions appropriate for consumer beverages, with the temperature being selected so as to assure a shelf life sufficient to accommodate the production process described herein.

The frozen sap is then partially thawed and the thawed portion extracted from the frozen portion (308). Due to the differential properties of the liquid solution, the thawed portion will generally include a much higher concentration of sugar and other solutes than the frozen portion. Thus, by capturing and processing only the liquid part of the partially-thawed sap, the resulting liquid may have a sugar level higher than that of the maple sap.

By carefully managing the temperature and degree of thawing, it may be possible to approach a desired sugar level for the thawed maple sap water product. For example, thawing approximately 50% by volume of sap with 1.5% sugar content may result in a liquid with nearly 3% sugar content. Once the target volume of thawed product has been collected, the sugar level of the thawed product can be tested (310) to determine if the sugar goal is reached (312).

If the sugar level is too low, additional water may be removed (314) by any method known in the art. Controlled reverse osmosis, as described earlier, may be used to remove additional water. In some implementations, a portion of the product may be selectively re-frozen. Other methods such as evaporation may also be used.

If the sugar level is too high, additional water may be introduced (316) by any appropriate method, such as by further thawing the frozen sap. As the remaining frozen liquid from the partial thawing process has a reduced sugar content, by thawing an additional controlled portion of the liquid, the sugar level can be reduced. Over time, the portion of sap product that is thawed may be adjusted according to the desired sugar level and the results of testing the thawed product.

Once the desired sugar level is reached, the product may be packaged and sanitized as described above, such as by means of HPP (318). In some implementations, the resulting product may be again frozen for further storage as described above with respect to method 100 (see FIG. 1).

The examples described above use HPP sanitation. It will be recognized that other methods of sanitation that can be used without heating the product, such as irradiation, may be used in place of HPP while still retaining at least some of the aforementioned advantages of the invention—that is, not fouling the flavor of the beverage by subjecting it to high heat. By combining low-temperature sanitation techniques with freezing for storage, maple beverage products with quality flavor may be provided to consumers year-round.

The present disclosure is not limited in scope by the specific embodiments described above. Indeed, other embodiments of, and modifications to, the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

What is claimed is:

1. A method for producing a maple beverage, comprising:
acquiring maple sap;
modifying a water content of the maple sap in order to produce a maple beverage product with a sugar content at a predetermined level;
applying high pressure processing to the maple beverage product; and
freezing the maple beverage product and storing the frozen maple beverage product;
wherein the maple sap and the maple beverage product are maintained at temperatures below 100° C. during production.

2. The method of claim 1, wherein the maple beverage product is frozen and stored before high pressure processing is applied.

3. The method of claim 1, wherein high pressure processing is applied before the maple beverage product is frozen and stored.

4. The method of claim 1, wherein the predetermined level is between 2.5% and 5% sugar content.

5. The method of claim 4, wherein the predetermined level is between 3% and 3.3% sugar content.

6. A method for producing a maple beverage, comprising:
acquiring maple sap;
removing water from the maple sap in order to produce a dehydrated maple sap product;
freezing the dehydrated maple sap product and storing the frozen dehydrated maple sap product;
after freezing and storing the dehydrated maple sap product, thawing the dehydrated maple sap product;
after thawing the dehydrated maple sap product, modifying a water content of the maple sap product in order to produce a maple beverage product with a sugar content at a predetermined level;
applying high pressure processing to the maple beverage product;
wherein the maple sap, the dehydrated maple sap product, and the maple beverage product are maintained at temperatures below 100° C. during production.

7. The method of claim 6, wherein the predetermined level is between 2.5% and 5% sugar content.

8. The method of claim 7, wherein the predetermined level is between 3% and 3.3% sugar content.

9. The method of claim 6, further comprising:
storing the water removed from the maple sap;
wherein modifying a water content of the maple sap product comprises adding water to the maple sap product that was previously removed from maple sap and stored.

10. A method for producing a maple beverage, comprising:
acquiring maple sap;
freezing the acquired maple sap;
partially thawing the frozen maple sap in order to produce a maple beverage product with a sugar content at a predetermined level; and
applying high pressure processing to the maple beverage product;
wherein the maple sap and the maple beverage product are maintained at temperatures below 100° C. during production.

11. The method of claim 10, wherein the predetermined level is between 2.5% and 5% sugar content.

12. The method of claim 11, wherein the predetermined level is approximately 3% and 3.3% sugar content.
